(19) United States
(12) Patent Application Publication
(10) Pub. No.: US 2006/0008721 A1
(43) Pub. Date: Jan. 12, 2006

(54) Color image forming developer and color image forming apparatus

(75) Inventor: Masashi Hirai, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 11/174,656

(22) Filed: Jul. 6, 2005

(30) Foreign Application Priority Data
Jul. 7, 2004 (JP) P2004-200877

(51) Int. Cl. G03G 9/09

(52) U.S. Cl. 430/107.1; 430/111.41

(57) ABSTRACT

A color image forming black developer is provided which has a volume resistivity equal to those of the respective color developers of yellow, magenta and cyan and makes it possible to obtain an image of high image quality. The color image forming developer uses, as a coloring agent of toner of a black developer, a coloring agent containing a yellow coloring agent used for a yellow developer, a magenta coloring agent used for a magenta developer and a cyan coloring agent used for a cyan developer at a predetermined ratio.

### BACKGROUND OF THE INVENTION

1. Field of the Invention

The present invention relates to a color image forming developer and a color image forming apparatus.

2. Description of the Related Art

In general, an image forming apparatus using the electrophotographic process is composed of a charging unit, an exposing unit, a developing unit, a transfer unit, a fixing unit and a cleaning unit, which are arranged around a photoconductor. The charging unit uniformly charges a surface of the photoconductor. The exposing unit exposes the charged photoconductor to light according to image information, and forms an electrostatic latent image on the surface of the photoconductor. The developing unit charges a developer by agitating, and forms a visible image by making the developer adhere to the electrostatic latent image formed on the surface of the photoconductor by electrostatic force. The transfer unit transfers a toner image to a recording material by giving the recording material an electric charge having the opposite polarity to that of toner. The fixing unit fixes the toner image transferred to the recording material by means of heating, pressuring or the like. The cleaning unit collects toner remaining on the surface of the photoconductor without being transferred to the recording material. The image forming apparatus by the electrophotographic process thus composed forms a desired image on a recording material.

In recent years, as documents are converted to color ones and display units of computers and the like are converted to color ones, color image forming apparatuses are being developed. One of the methods for forming a color image is to color-separate color image information into the respective hues of yellow, magenta and cyan, develop by the use of a color image forming developer responsive to the color-separated image information, and form a full-color image by utilizing the subtractive color mixture action.

In the case of superposing color developers of yellow, magenta and cyan with the intent of expressing black by this method, it is possible to artificially express black, but it does not become perfect black, and favorable black chromaticity cannot be obtained. Therefore, a color image forming apparatus having a black developer as well as color developers of yellow, magenta and cyan is generally used.

Some image forming apparatuses are equipped with image forming portions each including a photoconductor, a charging unit, a developing unit, a transfer unit and a cleaning unit for each of color developers of yellow, magenta and cyan and a black developer. Such a color image forming apparatus is widely used, because it can simultaneously form visible images of the respective colors on surfaces of the respective photoconductors, and therefore perform high speed full-color image formation.

A developer used in a color image forming apparatus contains a binding resin and a coloring agent, and further, a charge control agent, a wax, an additive and the like which are added as necessary. The binding resin is a resin for dispersing and molding a coloring agent, a charge control agent, a wax and the like which cannot be molded alone. As the coloring agents contained in color developers of yellow, magenta and cyan are used color materials such as organic pigments or dyes, and as a coloring agent contained in a black developer, carbon black is used heretofore, because it is low-cost and capable of expressing black alone.

Content of a coloring agent to a developer, however, is generally 5 to 10% by weight and is higher than the other additives. Therefore, when the black developer using carbon black of low electrical resistance as a coloring agent is used in a color image forming apparatus, a difference in charge property is generated between the black developer and the color developers using dye or pigments of high electrical resistance. Since there is a difference in charge property between the black developer and the color developers in this manner, the black developer adheres to the photoconductor by stronger force than the color developers in the case where the photoconductors for the color developers and the black developer are charged and the developers are agitated for charging in a developing unit under the same conditions. As a result, such a problem occurs that only black is printed in high density, the color tones of an image do not match, and the quality of the image deteriorates.

Accordingly, it is proposed recently to collect powdered color developers which are generated at the time of production of color developers of yellow, magenta and cyan and cannot be used as the color developers, reuse the collected color developers as part or all of the raw material for producing the black developer, and melt, knead and crush them to obtain a black developer (refer to Japanese Unexamined Patent Publication JP-A 4-39672 (1992), for example). The black developer thus obtained is considered to show the same action as the color developers of yellow, magenta and cyan with regard to a charge property at the time of development.

Another related art proposes a black developer which is produced by the emulsion polymerization method by the use of a coloring agent obtained by mixing the respective coloring agents of yellow, magenta and cyan at a predetermined ratio (refer to Japanese Unexamined Patent Publication JP-A 2002-182431, for example). Since this black developer has high black chromaticity and an excellent charge property, it is considered to realize excellent black-color fixation.

In the case of using the abovementioned developers such that the charge properties of the color developers of yellow, magenta and cyan and the charge property of the black developer are similar in a color image forming apparatus, it is certainly possible to set the conditions of agitating the developers, the conditions of applying development bias and so on to the same ones, and make the adhesion states of the developers to photoconductors the same in the developing process. However, even if developers showing the same actions with regard to charge properties are obtained, there is no guarantee that the value of the volume resistivity of the black developer and the value of the volume resistivities of the color developers are the same. In the case where there is a difference between the volume resistivity of the black developer and the volume resistivities of the color developers of yellow, magenta and cyan, the charge properties of the respective developers change through the transfer process and the cleaning process after the developing process, and differences in transfer efficiency and cleaning efficiency are generated between the color developers of yellow, magenta and cyan and the black developer. As a result, an image obtained in the transfer process is of low image quality, because the harmony of colors is not maintained. Moreover, there is a difference of the amounts of toner remaining after being transferred between the black developer and the color developers, so that there is a possibility that when cleaning is performed under the same conditions, some toner remains without being cleaned and causes the mixture of colors in the following printing process.

Accordingly, in the transfer process, in order to match the color tints of the black developer and the color developers and increase the image quality, there is a need to set a voltage applied for transferring the developer to a recording material, for each of the black developer and the color developers of yellow, magenta and cyan. Moreover, in the cleaning process, there is a need to perform cleaning depending on the remaining toner of each, and the contact pressure of a cleaning blade which collects toner remaining on the surface of the photoconductor, with respect to the photoconductor must be set for each, so that the operation conditions of the image forming apparatus should become complicated.

### SUMMARY OF THE INVENTION

An object of the invention is to provide a color image forming black developer which has a volume resistivity equal to those of the respective color developers of yellow, magenta and cyan and makes it possible to obtain an image of high image quality, and provide a color image forming apparatus which is equipped with the developer and has a simple configuration.

The invention provides a color image forming developer for use in visualizing a latent image which is formed on the basis of image information separated into color components of yellow, magenta, cyan and black, the color image forming developer comprising:
a yellow developer which develops a latent image formed on the basis of image information relating to the color component of yellow;
a magenta developer which develops a latent image formed on the basis of image information relating to the color component of magenta;
a cyan developer which develops a latent image formed on the basis of image information relating to the color component of cyan; and
a black developer which develops a latent image formed on the basis of image information relating to the color component of black,
wherein a volume resistivity of the black developer is substantially equal to a volume resistivity of the yellow developer, a volume resistivity of the magenta developer, and a volume resistivity of the cyan developer.

Further, in the invention, it is preferable that each of the developers contains at least a binding resin and a coloring agent, and
the black developer contains a yellow coloring agent, a magenta coloring agent and a cyan coloring agent which are used for the yellow developer, the magenta developer and the cyan developer, respectively, at a predetermined ratio.

Furthermore, in the invention, it is preferable that the predetermined ratio is such that weights of the yellow coloring agent, the magenta coloring agent and the cyan coloring agent are in substantially equal proportions.

Furthermore, in the invention, it is preferable that the predetermined ratio is 1:1:1 by weight.

Furthermore, in the invention, it is preferable that the predetermined ratio is (1.2-1.5):1:1 by weight.

Still further, in the invention, it is preferable that a ratio of the sum of the weights of the yellow coloring agent, the magenta coloring agent and the cyan coloring agent in the black developer to the weight of the black developer is substantially equal to a ratio of the weight of the yellow coloring agent in the yellow developer to the weight of the yellow developer, a ratio of the weight of the magenta coloring agent in the magenta developer to the weight of the magenta developer, and a ratio of the weight of the cyan coloring agent in the cyan developer to the weight of the cyan developer.

Still further, the invention provides a color image forming apparatus in which a latent image which is formed on the basis of image information separated into color components of yellow, magenta, cyan and black is visualized, the color image forming apparatus comprising:
a photoconductor on which a latent image is formed by being exposed to light according to image information;
a charging unit which charges the photoconductor before being exposed;
a developing unit which is equipped with the color image forming developer mentioned above, agitates and charges the color image forming developer, and supplies the color image forming developer to the surface of the photoconductor to visualize the latent image;
a transfer unit which applies electric potential of an opposite polarity to a polarity of the color image forming developer to a to-be-transferred material and transfers the visualized image; and
a cleaning unit which removes the color image forming developer that remains on the surface of the photoconductor after transfer,
wherein at the time of image formation, the operation conditions of the charging unit, the developing unit, the transfer unit and the cleaning unit are set to same ones for the respective color developers of yellow, magenta and cyan and the black developer.

Still further, in the invention, it is preferable that the operation conditions include at least charge electric potential at which the charging unit charges the photoconductor, an application voltage of a developer tank which contains the developer and a condition of agitating the developer in the developing unit, transfer electric potential at which the transfer unit applies to the to-be-transferred material, and a contact pressure of the cleaning unit to the surface of the photoconductor.

According to the invention, the volume resistivity of the black developer is substantially equal to the volume resistivities of the color developers of yellow, magenta and cyan (hereinafter, referred to as color developers) so that a difference is not generated between the charge property of the black developer and the charge properties of the color developers in the respective processes for forming a color image. Therefore, it is possible to obtain an image of high image quality in which the harmony of colors is maintained, and it is possible to set the charge electric potential at which the charging unit charges the photoconductor, the application voltage of the developer tank that contains the developer and the condition of agitating the developer in the developing unit, the transfer electric potential at which the transfer unit applies to the to-be-transferred material, and the contact pressure of the cleaning unit to the surface of the photoconductor to the same ones, for the black developer and the color developers.

Further, according to the invention, a coloring agent used for the black developer contains a yellow coloring agent, a magenta coloring agent and a cyan coloring agent which are used for the yellow developer, the magenta developer and the cyan developer, respectively, at a predetermined ratio, so that it is possible to obtain a color image forming black developer which has a volume resistivity equal to those of the color developers.

Furthermore, according to the invention, the predetermined ratio of the coloring agents used for the black developer is such that the weights of the coloring agents of the respective colors, that is, the weight of the yellow coloring agent, the weight of the magenta coloring agent and the weight of the cyan coloring agent are in substantially equal proportions, and the coloring agents of the respective colors are mixed at a favorable ratio, so that it is possible to obtain a color image forming black developer which has high black chromaticity and is excellent in image quality.

Still further, according to the invention, a ratio of the sum of the weights of the yellow coloring agent, the magenta coloring agent and the cyan coloring agent in the black developer to the weight of the black developer is substantially equal to a ratio of the weight of the yellow coloring agent in the yellow developer to the weight of the yellow developer, a ratio of the weight of the magenta coloring agent in the magenta developer to the weight of the magenta developer, and a ratio of the weight of the cyan coloring agent in the cyan developer to the weight of the cyan developer, so that the relation between the densities of images formed by the color developers and the density of an image formed by the black developer becomes favorable, and it is possible to form an image of excellent image quality as a whole color image.

Still further, according to the invention, in a color image forming apparatus equipped with the aforementioned color image forming developer, the volume resistivities of the color developers and the volume resistivity of the color image forming black developer are substantially equal, so that at the time of image formation, the operation conditions of the charging unit, the developing unit, the transfer unit and the cleaning unit can be set to the same ones, for the color developers and the black developer. Therefore, it is not necessary to regulate the settings of the operation conditions between the color developers and the black developer, so that it is possible to obtain a color image forming apparatus that has a simpler configuration.

Still further, according to the invention, the operation conditions include at least the charge electric potential at which the charging unit charges the photoconductor, the application voltage of the developer tank that contains the developer and the condition of agitating the developer in the developing unit, the transfer electric potential at which the transfer unit applies to the to-be-transferred material, and the contact pressure of the cleaning unit to the surface of the photoconductor, and it is possible to set the configurations and so on of voltage applying means which applies a voltage, developer agitating means in the developer tank and the cleaning unit to the same ones, so that the need for individually setting the operation conditions for the color developers and the black developer is eliminated. Moreover, since the components can be made to be common, it is possible to obtain a color image forming apparatus that has a simpler configuration and is miniaturized.

### BRIEF DESCRIPTION OF THE DRAWINGS

Other and further objects, features, and advantages of the invention will be more explicit from the following detailed description taken with reference to the drawings wherein:

FIG. 1 is a schematic cross section view showing, in a simplified manner, the structure of toner of a black developer according to one embodiment of the color image forming developer of the invention;

FIG. 2 is a schematic cross section view showing, in a simplified manner, the structures of toners of color developers of yellow, magenta and cyan;

FIG. 3 is a cross section view showing, in a simplified manner, the entire configuration of a color image forming apparatus according to another embodiment of the invention;

FIG. 4 is a magnified view of the essential part of the color image forming apparatus shown in FIG. 3;

FIG. 5 is a magnified view of the essential part of a color image forming apparatus according to still another embodiment of the invention;

FIG. 6 is a schematic cross section view showing, in a simplified manner, the structure of toner of the black developer using carbon black as a coloring agent according to a comparative example to the invention; and

FIG. 7 shows the result of measurement of electrical resistance in the developer of the invention and in the black developer of the comparative example.

### DETAILED DESCRIPTION OF THE PREFERRED EMBODIMENTS

Now referring to the drawings, preferred embodiments of the invention are described below.

The color image forming developer of the invention is characterized in that a volume resistivity of a black developer is substantially equal to a volume resistivity of a yellow developer, a volume resistivity of a magenta developer, and a volume resistivity of a cyan developer.

In producing such a developer, for example, it is preferable that the black developer contains a yellow coloring agent, a magenta coloring agent and a cyan coloring agent which are used for the yellow developer, the magenta developer and the cyan developer, respectively, at a predetermined ratio as a coloring agent. Hereinafter, a method for producing the black developer will be described.

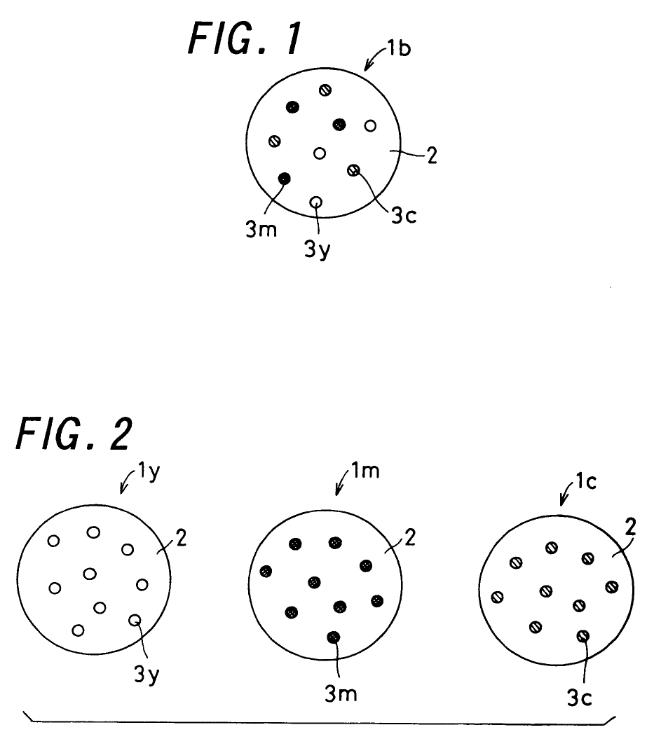

FIG. 1 is a schematic cross section view showing, in a simplified manner, the structure of toner 1b of a black developer according to one embodiment of the color image forming developer of the invention, and FIG. 2 is a schematic cross section view showing, in a simplified manner, the structures of toners 1y, 1m, 1c of color developers of yellow, magenta and cyan. In the following description, alphabetical letters y, m, c, b attached to the respective Arabic numerals correspond to the colors of yellow, magenta, cyan and black, respectively. Hereinafter, except the case of a description by specifying a specific color, the alphabetical letters y, m, c, b will be omitted in the description.

The toner 1 of the color image forming developer of the invention contains at least a binding resin 2 and a coloring agent 3.

The binding resin 2 is, for example, polystyrene, styrene-acrylic ester-based styrene resins, vinyl chloride resins, phenol resins, epoxy resins, polyester resins or the like. A vinyl-based monomer which can be polymerized with styrene used for styrene-acrylic ester-based styrene resins is: acrylic esters having ethylenic double bond, such as acrylic acid, methyl acrylate, ethyl acrylate, butyl acrylate, dodecyl acrylate, octyl acrylate, 2-ethylhexyl acrylate, phenyl acrylate, methyl methacrylate, ethyl methacrylate, butyl methacrylate, octyl methacrylate, acrylonitrile, methacrylonitrile and acrylamide; maleic acid half esters and diesthers such as maleic acid and butyl maleate; vinyl esters such as vinyl acetate, vinyl chloride, vinyl methyl ether, vinyl ethyl ether, vinyl propyl ether and vinyl butyl ether; and vinyl ketones such as vinyl methyl ketone, vinyl ethyl ketone and vinyl hexyl ketone.

A yellow coloring agent 3y is used as the coloring agent of the toner 1y of the yellow developer, a magenta coloring agent 3m is used as the coloring agent of the toner 1m of the magenta developer, and a cyan coloring agent 3c is used as the coloring agent of the toner 1c of the cyan developer. Moreover, as the coloring agent of the toner 1b of the black developer, the yellow coloring agent 3y, the magenta coloring agent 3m and the cyan coloring agent 3c used for the respective toners of the yellow developer, the magenta developer and the cyan developer are used.

The yellow coloring agent 3y is, for example, disazo pigments such as C.I. pigment yellow 17, monoazo pigments such as C.I. pigment yellow 74 and C.I. pigment yellow 97, condensed azo pigments such as C.I. pigment yellow 93 and C.I. pigment yellow 128, benzimidazolone pigments such as C.I. pigment yellow 180 and C.I. pigment yellow 194, or the like.

The magenta coloring agent 3m is, for example, quinacridone pigments such as C.I. pigment red 122 and C.I. pigment red 202, lake azo pigments such as C.I. pigment red 57:1, perylene pigments such as C.I. pigment red 149, C.I. pigment red 190 and C.I. pigment red 224, naphthol-benzimidazolone pigments such as C.I. pigment red 184 and C.I. pigment red 185, or the like.

The cyan coloring agent 3c is, for example, phthalocyanine pigments such as C.I. pigment blue 15, C.I pigment blue 15:3 and C.I. pigment blue 15:4.

Here, the toner 1b of the black developer in the color image forming developer of the invention contains the yellow coloring agent 3y, the magenta coloring agent 3m and the cyan coloring agent 3c at a predetermined ratio. Here, the predetermined ratio is such that weights of the yellow coloring agent 3y, the magenta coloring agent 3m and the cyan coloring agent 3c are in substantially equal proportions.

By equally mixing the coloring agents of the respective colors of yellow, magenta and cyan at a ratio of 1:1:1 by weight, it is possible to obtain a coloring agent of black color. However, even if the densities are equal, they may not look like equal by human vision in the case of different hues, and especially, the density of yellow is often visually felt to be low as compared with the other hues. Therefore, there is a case where an obtained coloring agent does not look like true black color even when the respective coloring agents of yellow, magenta and cyan are equally mixed, so that it is preferable to mix yellow, magenta and cyan at a ratio of, for example, (1.2-1.5):1:1 by weight, which is a ratio such that a ratio of the mixed yellow coloring agent 3y is slightly higher. This is made in consideration of the amounts of the developers of the respective hues in order to obtain the same densities in the same areas, and is determined from the ratio of the amounts of the developers of the respective hues in order to obtain ID density of 1.4 (saturation density). Therefore, the weights being in substantially equal proportions includes a case where a ratio of yellow is slightly higher than a ratio of magenta and a ratio of cyan and a case where a ratio of yellow, a ratio of magenta and a ratio of cyan are the same.

It is preferable that 5-10% by weight of the coloring agents 3y, 3m, 3c in the yellow, magenta, cyan and black developers are contained in the toners 1. In the case of less than 5% by weight of the coloring agents, an image having sufficient image density cannot be obtained. In the case of over 10% by weight, the dispersiveness of the coloring agents in the binding resin becomes bad.

Further, it is preferable that a ratio of the sum of the weights of the yellow coloring agent 3y, the magenta coloring agent 3m and the cyan coloring agent 3c in the black developer to the weight of the toner 1b of the black developer is substantially equal to a ratio of the weight of the yellow coloring agent 3y in the yellow developer to the weight of the toner ly of the yellow developer, a ratio of the weight of the magenta coloring agent 3m in the magenta developer to the weight of the toner 1m of the magenta developer, and a ratio of the weight of the cyan coloring agent 3c in the cyan developer to the weight of the toner 1c of the cyan developer. Here, the language “substantially equal” means that a proportion of the density of the coloring agent 3 in the toner 1b of the black developer to the density of the coloring agents 3 in the toners 1y-c of the yellow, magenta and cyan developers is 0.9-1.1.

The toner 1 may contain, in addition to the binding resin 2 and the coloring agent 3, an additive such as a charge control agent in the range that a preferable property is not impaired. By adding the charge control agent, it is possible to make the friction charge amount of the toner 1 favorable. As the charge control agent, it is possible to use a well-known one, which is, for example, a colorless positive charge control agent represented by metal salt of quaternary ammonium salt, and a colorless negative charge control agent represented by metal salt of alkyl salicyl. It is preferable that 2% by weight of the charge control agent is contained in the toner 1 in general.

Further, in addition to the binding resin 2 and the coloring agent 3, a release agent such as wax may be contained in the range that a favorable property is not impaired. As the wax, it is possible to use a well-known one, which is, for example, silicone varnish and silicone oil. It is preferable that 3% by weight of the wax is contained in the toner 1 in general.

The toner 1 of the color image forming developer of the invention can be obtained by a well-known method. For example, a method to mix the charge control agent, the wax and so on as necessary into principal ingredients such as the binding resin 2 and the coloring agent 3 or into a so-called masterbatch composition in which the coloring agent 3 is preliminary-dispersed in the binding resin 2 in advance, by a mixing machine, and thereafter, melt-knead, uniformly disperse, crush, and classify is used.

As the mixing machine, a Henschel-type mixing apparatus such as a Henschel mixer (produced by MITSUI MINING Co., LTD.), a super-mixer (produced by KAWATA MFG Co., Ltd.) or a MECHANOMILL (produced by Okada Seiko Co., Ltd.), or an apparatus such as an Angmill (produced by Hosokawamicron Corporation), a HYBRIDIZATION SYSTEM (produced by Nara Machinery Co., Ltd.) or a COSMOSYSTEM (produced by Kawasaki Heavy Industries, Ltd.) can be used, and as a kneading machine, a uniaxial or biaxial extruder such as TEM-100B (produced by Toshiba Machine) or PCM-65/87 (produced by Ikegai), or an open-roll-type machine such as a Kneadex (produced by MITSUI MINING Co., LTD.) can be used. In specific, in the melting-kneading process, in order to efficiently disperse the additive, it is desirable to knead by high shearing force at low temperatures so that the resin viscosity at the time of melting does not decrease too much, in particular, it is preferable to use an open-roll-type kneading machine in specific.

To crush toner particles, a collision-type air flow crusher using jet air flow, a mechanical crusher or the like can be used, and the toner particles are subjected to classification by wind force and regulated to a predetermined particle size.

Further, the toner 1 of the color image forming developer of the invention can also be obtained by a so-called polymerization method such as the suspension method, the emulsion aggregation method or the liquid dry method to generate particles in an aqueous solution or a solvent.

It is preferable that the toner particles thus produced have a volume average particle diameter of 3 to 10 μm. In the case where the volume average particle diameter of the toner is less than 3 μm, the toner particle diameter becomes too small, and the toner is not stably supplied to the photoconductor, whereby there are fears that image fog occurs. On the other hand, in the case where the volume average particle diameter of the toner exceeds 10 μm, the particle diameter of the toner is large, so that an image of high image quality cannot be obtained.

Furthermore, it is preferable that the particle size distribution of the toner particles thus produced is narrow, but it is possible to use ones having a particle size which can be obtained by a normal crushing method. In specific, it is preferable to regulate so that with respect to a volume average particle diameter D50, particles having a particle diameter of 0.5×D50 are 20% by number or less and particles having a particle diameter of 2×D50 or more are 2% by volume or less.

Into the toner 1 thus obtained, an external additive which has functions of, for example, increase of the powder fluidity, increase of a friction charge property, improvement of a heat-resistance property and a long-term preservation property, improvement of a cleaning property, control of the abrasion property of the surface of the photoconductor, and the like may be mixed. The external additive is, for example, silica fine powder, titanium oxide fine powder, alumina fine powder and the like. An addition amount of the external additive favorable in practical use is 1 part by weight or less with respect to 100 parts by weight of toner particles in consideration of application of a necessary charge amount for the toner, an influence on the photoconductor, environmental characteristics of the toner and so on.

In the color image forming developer of the invention containing the toner 1 thus produced, the volume resistivity of the black developer is substantially equal to the volume resistivity of the yellow developer, the volume resistivity of the magenta developer, and the volume resistivity of the cyan developer. Therefore, a difference is not generated between the charge property of the black developer and the charge properties of the color developers of yellow, magenta and cyan in the respective processes such as the developing process and the transfer process, so that it is possible to obtain an image of high image quality in which the harmony of colors is maintained.

The color image forming developer of the invention can also be a two-component developer made by forming in the above manner and mixing a carrier into the toner 1 with an external additive added as necessary. As the carrier used for the two-component developer, it is possible to use a well-known one, which is, for example, a ferrite carrier and an iron powder carrier. In a preferable mixture ratio on this occasion, 3 to 8% by weight of the toner 1 is contained in the two-component developer.

Further, in the case of using the two-component developer as the color image forming developer of the invention, it is preferable that the volume resistivity of the toner 1b of the black developer is substantially equal to the volume resistivity of the toner 1y of the yellow developer, the volume resistivity of the toner 1m of the magenta developer, and the volume resistivity of the toner 1c of the cyan developer. In the case of the two-component developer, by making the volume resistivities of the respective toner substantially equal, it is possible to prevent generation of a difference in charge property not only in the developing process but also in the transfer process and the cleaning process.

Hereinafter, a color image forming apparatus according to another embodiment of the invention in which the color image forming developer of the invention is used in a favorable manner will be described.

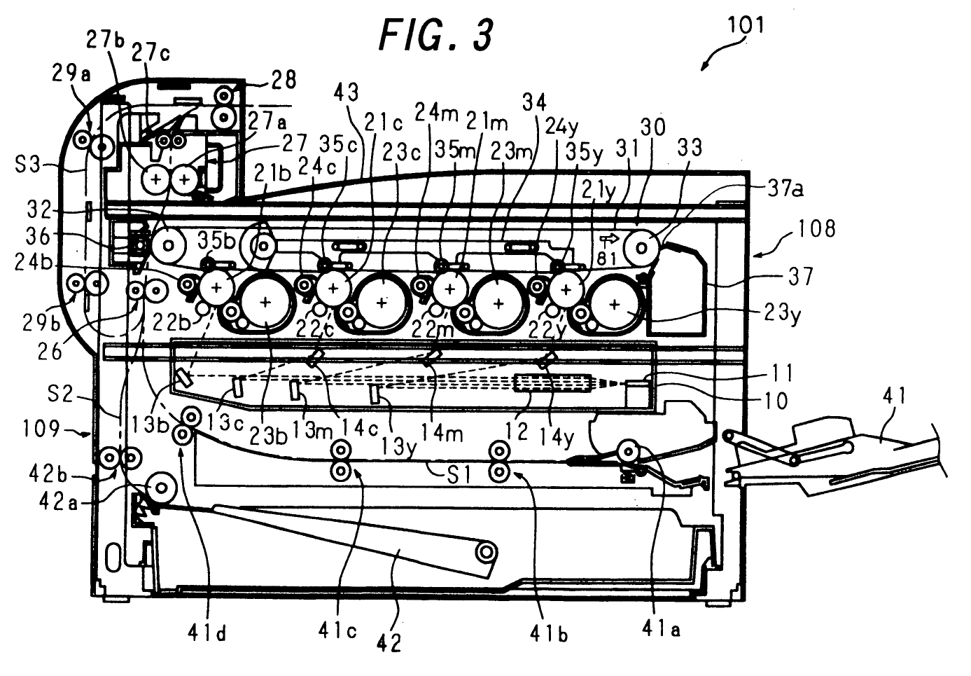

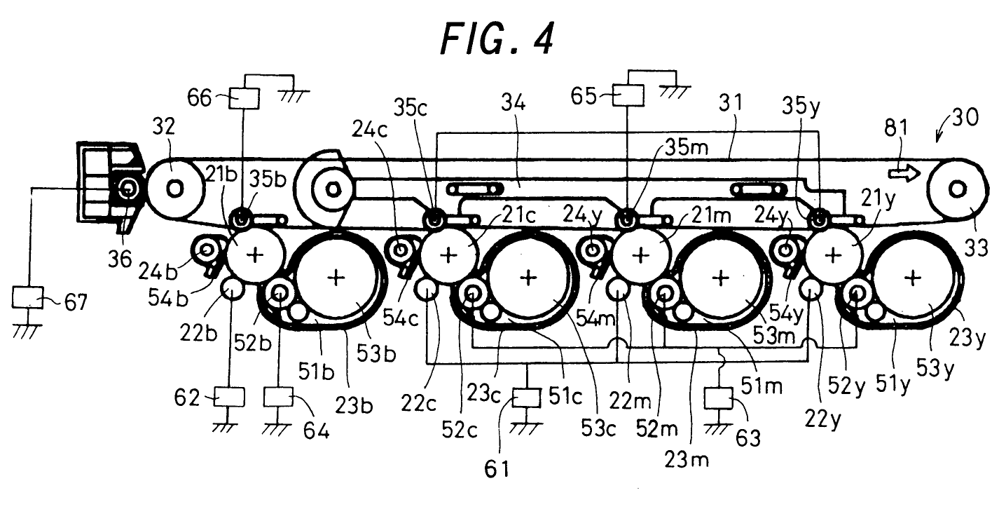

FIG. 3 is a cross section view showing, in a simplified manner, the entire configuration of a color image forming apparatus 101 according to another embodiment of the invention, and FIG. 4 is a magnified view of the essential part of the color image forming apparatus 101 shown in FIG. 3. In the color image forming apparatus 101, a yellow developer 51y, a magenta developer 51m, a cyan developer 51c and a black developer 51b each containing the toner 1 of the color image forming developer described above are used for development.

The color image forming apparatus 101 is basically composed of an image forming portion 108 and a paper feeding portion 109, and forms a polychrome image or a monochrome image on a sheet of paper on the basis of a printing job from an information processing apparatus (not shown) such as a personal computer connected externally.

Hereinafter, the configuration and operation of the image forming portion 108 will be described. In the image forming portion 108, alphabetical letters y, m, c, b attached to the respective Arabic numerals correspond to the colors of yellow, magenta, cyan and black, respectively. Hereinafter, except a case of a description by specifying a member associated with a specific color, the alphabetical letters y, m, c, b on members disposed for the respective colors will be omitted in the description. Moreover, “y-c” and “y-b” refer to “y, m, c” and “y, m, c, b,” respectively.

The image forming portion 108 comprises: photoconductors 21y, 21m, 21c, 21b disposed for the respective colors of yellow, magenta, cyan and black in order to form a polychrome image by the use of the respective colors; charging units 22y, 22m, 22c, 22b each of which is arranged around the photoconductor and charges the photoconductor 21; developing units 23y, 23m, 23c, 23b each of which supplies each of the aforementioned developers to the surface of the photoconductor 21 and forms a toner image; cleaning units 24y, 24m, 24c, 24b each of which is arranged around the photoconductor and collects toner remaining on the surface of the photoconductor 21; an exposing unit 10 that forms an electrostatic latent image on the surface of the photoconductor 21 with light responsive to image information; a transfer belt unit 30 that includes a transfer belt 31 to which the toner images on the surfaces of the photoconductors 21 are temporarily transferred; and a transfer roller 36 that transfers a polychrome toner image transferred to the transfer belt 31, to a sheet of paper. A transfer unit includes the transfer belt unit 30 and the transfer roller 36.

The charging units 22 uniformly charge the surfaces of the photoconductors 21 at a predetermined electric potential, respectively. The charging units 22 are disposed so as to come in contact with the photoconductors 21, and provided with charge voltage applying means 61, 62 for uniformly charging the photoconductors 21 at a predetermined electric potential, respectively. The charging unit 22 of the color image forming apparatus 101 of the invention is a roller-type charging unit, but may be a charging unit of a brush type or a charger type, instead of the roller-type. As the charge voltage applying means 61, 62, for example, a rectifying unit having a transformer and a rectifier, a converter or the like is used, and the charge voltage applying means 61 applies voltages to the charging units 22y-c and charges the photoconductors 21y-c, whereas the charge voltage applying means 62 applies a voltage to the charging unit 22b and charges the photoconductor 21b. In the color image forming apparatus of the present embodiment, a single charge voltage applying means is used as the charge voltage applying means for yellow, magenta and cyan, so that it is possible to seek reduction of the component count and miniaturization of the apparatus.

The exposing unit 10 is formed by a laser scanning unit (LSU) equipped with a laser irradiating portion 11, and a polygon mirror 12 and reflection mirrors 13y, 13m, 13c, 13b, 14y, 14m, 14c are disposed in positions such that they can apply a laser beam emitted from the laser irradiating portion 11 to the surfaces of the photoconductors 21. Instead of the laser irradiating portion 11, a writing head in which light emitting elements such as ELs (electroluminescences) or LEDs (light emitting diodes) are arranged into an array may be used. The exposing unit 10 emits a laser beam from the laser irradiating portion 11 in response to image information, and exposes the laser light to the surfaces of the photoconductors 21 uniformly charged by the charging units 22 via the polygon mirror 12 and the reflection mirrors 13, 14, thereby forming electrostatic latent images composed of exposed portions and unexposed portions with different charging amounts on the surfaces of the photoconductors 21.

The developing units 23 are arranged so as to face the photoconductors 21, contain developers of the respective colors of the yellow developer 51y, the magenta developer 51m, the cyan developer 51c and the black developer 51b as the color image forming developer of the invention in developer containing vessels (not shown), and include developing rollers 52y, 52m, 52c, 52b that supply the developers to the surfaces of the photoconductors 21, agitating rollers 53y, 53m, 53c, 53b that agitate the developers 51, and developing bias applying means 63, 64 serving as developing bias applying means.

In the developing unit 23, the developing roller 52 has a cylindrical shape and is rotatably supported within the developing unit via a rotation shaft (not shown), and driven to rotate in a fixed direction by a motor (not shown).

The agitating roller 53 is arranged within the developing unit 23 so as to locate on the opposite side to the photoconductor 21 about the developing roller 52, and rotatably supported in a fixed direction about the axial line thereof. The agitating roller 53 agitates the developer 51 and supplies the developer 51 to the developing roller 52. The agitation property of the agitating roller 53 determines the charge amount of the developer 51, but in the color image forming apparatus 101 of the invention, the volume resistivity of the black developer 51b is substantially equal to the volume resistivities of the color developers 51y-c of yellow, magenta and cyan, so that a difference is not generated in charge amounts of the respective developers even if the agitating rollers 53y, 53m, 53c, 53b of the same shapes and materials are used. Therefore, it is possible to simplify the setting of the conditions of agitating the developers, and it is possible to seek reduction of the kinds of components, so that it is possible to realize cost reduction.

As the developing bias applying means 63, 64, for example, a rectifying unit provided with a transformer and a rectifier, a converter or the like is used. The developing bias applying means 63 charges the developing rollers 52y-c, whereas the developing bias applying means 64 charges the developing roller 52b. In the color image forming apparatus of the present embodiment, a single developing bias applying means is used as the developing bias applying means for yellow, magenta and cyan, so that it is possible to seek reduction of the component count and miniaturization of the apparatus.

In the developing unit 23, the developer 51 supplied to the developing roller 52 while being agitated by the agitating roller 53, is supplied to the electrostatic latent image which is formed on the surface of the photoconductor 21 by the exposing unit 10, to form a toner image on the surface of the photoconductor 21, by rotation of the developing roller 52 and developing bias applied to the developing roller 52.

Further, the color image forming apparatus 101 of the invention does not employ a method of transferring a toner image formed on the photoconductor 21 directly to a sheet of paper, but employs a method of performing a first transfer process of once transferring by laminating toner images formed on the surfaces of the photoconductors 21, to the transfer belt 31 in the order of yellow, magenta, cyan and black, and thereafter, performing a second transfer process of transferring onto a sheet of paper fed from the paper feeding portion 109.

As a first transfer unit, the transfer belt unit 30 serving as the transfer unit relating to the invention is mounted above the photoconductors 21. The transfer belt unit 30 has the transfer belt 31, a transfer belt driving roller 32, a transfer belt driven roller 33, a transfer belt tension mechanism 34, and intermediate transfer rollers 35y, 35m, 35c, 35b.

The transfer belt driving roller 32 and the transfer belt driven roller 33 stretch out the transfer belt 31 to be belted, and rotate the transfer belt 31 in the direction of an arrow 81 when the driving force of the transfer belt driving roller 32 driven to rotate by the motor is transmitted to the transfer belt 31. The transfer belt 31 is formed into an endless shape by the use of, for example, a film having a thickness of 75 to 120 μm, and the photoconductors 21 come in contact with the surface thereof. By transferring toner images of the respective colors formed on the surfaces of the photoconductors 21 in the order of yellow, magenta, cyan and black so as to be superposed, a color toner image (polychrome toner image) is formed on the transfer belt 31.

Transfer of a polychrome toner image from the photoconductors 21 to the transfer belt 31 is performed by the intermediate transfer rollers 35 that come in contact with a back side of the transfer belt 31. The intermediate transfer roller 35 is formed so that the surface of a metal shaft body having a diameter of 8 to 10 mm made of stainless steel or the like is covered with an elastic material such as EPDM with an electrically conductive filler added or urethane foam, for example. With the elastic material having electrical conductivity, the intermediate transfer rollers 35 apply voltages uniformly to the transfer belt 31, and transfer a polychrome toner image to the transfer belt 31. As means for applying voltages to the intermediate transfer rollers 35 in the first transfer process, the first transfer voltage applying means 65, 66 are used. The first transfer voltage applying means 65, 66 apply voltages of the opposite polarity to the charge polarity of toner, to the intermediate transfer rollers 35, and as the first transfer voltage applying means, for example, a rectifying unit provided with a transformer and a rectifier, a converter or the like is used. The first transfer voltage applying means 65 charges the intermediate transfer rollers 35y-c, and the first transfer voltage applying means 66 charges the intermediate transfer roller 35b. In the color image forming apparatus of the present embodiment, a single first transfer voltage applying means is used as the first transfer voltage applying means for yellow, magenta and cyan, so that it is possible to seek reduction of the component count and miniaturization of the apparatus.

The cleaning units 24 remove and collect toner remaining on the surfaces of the photoconductors 21 after toner images are transferred to the transfer belt 31. The cleaning units 24 are respectively composed of cleaning blades 54y, 54m, 54c, 54b made of an elastic material or the like, and so on.

In the case of using the color image forming developer of the invention, a difference is not generated between the charge property of the black developer 51b and the charge properties of the color developers 51y-c, so that it is possible to make the adhesion forces of toner remaining on the surfaces of the photoconductors 21 approximately the same. Therefore, it is possible to use the same shape and material of cleaning blades 54 for all the developers, so that it is possible to seek cost reduction by reduction of the kinds of members, and it is possible to realize simplification of the setting of the operation conditions. Moreover, since the volume resistivities of the respective developers 51 are substantially equal, it becomes relatively easy to set the respective voltages so that the amount of remaining toner becomes small, and it is also possible to miniaturize the vessel for collecting removed toner.

In the second transfer process, a polychrome toner image formed by laminating on the intermediate transfer belt 31 is transferred onto a sheet of paper by rotation of the transfer belt 31 and rotation of the transfer roller 36 arranged in the position where the sheet of paper and the transfer belt 31 come in contact with each other. On this occasion, the transfer roller 36 and the transfer belt 31 are pressed against each other, and a high voltage of the opposite polarity to the charge polarity of toner is applied to the transfer roller 36 by second transfer voltage applying means 67 in order to transfer the polychrome toner image to the sheet of paper. As the second transfer voltage applying means 67, for example, a rectifying unit provided with a transformer and a rectifier, a converter or the like is used. Moreover, in order to make the contact pressure between the transfer belt 31 and the transfer roller 36 constant, one of the transfer belt driving roller 32 and the transfer roller 36 is made of a hard material such as metal, and the other is made of a soft material such as elastic rubber or a foamed resin.

In the second transfer process, the need for changing the setting of the transfer conditions between the case of transferring a polychrome toner layer and the case of transferring a monochrome toner layer is eliminated, because the volume resistivities of all the developers are substantially equal values. Therefore, in the second transfer voltage applying means, the voltage can be set in consideration of only the kind of a conveyed sheet of paper, so that it is possible to make the apparatus have a simpler configuration.

Toner remaining on the transfer belt 31 without being transferred onto a sheet of paper by the transfer roller 36 is removed and collected by a transfer belt cleaning unit 37 disposed near the transfer belt driven roller 33, because it causes a mixture of colors of toner in the following image forming process. The transfer belt cleaning unit 37 is equipped with a cleaning blade 37a arranged so as to abut against the transfer belt 31.

In the case of using the color image forming developer of the invention, the volume resistivities of the developers are substantially equal, and the adhesion forces of toners remaining on the transfer belt 31 becomes the same, so that it becomes relatively easy to set the respective voltages so that the amount of remaining toner becomes small. Therefore, it is possible to miniaturize the vessel for collecting removed toner, thereby achieving space saving as the whole apparatus, and it is possible to decrease load to the cleaning blade 37a.

Thus, the image forming portion 108 included in the image forming apparatus 101 of the invention forms a desired image on a sheet of paper. Hereinafter, the configurations and operations of the paper feeding portion 109 and a fixing unit 27 will be described.

The paper feeding portion 109 includes a manual-bypass tray 41 and a paper feeding cassette 42 that contain sheets of paper used for image formation. The manual-bypass tray 41 is attached externally to the casing of the image forming apparatus 101, and a small number of desired sheets of paper are placed thereon and taken into the image forming apparatus 101. On the other hand, the paper feeding cassette 42 is disposed below the image forming portion 108 and the exposing unit 10, and contains a large number of sheets of paper of a size prescribed by the apparatus or a predetermined size. The sheets of paper placed on the manual-bypass tray 41 are taken into the apparatus by a pickup roller 41a at a timing directed through an operation panel (not shown), and conveyed to the image forming portion 108 by conveying rollers 41b, 41c, 41d disposed along a sheet of paper conveying path S1. On the other hand, the sheets of paper contained in the paper feeding cassettes 42 are separately fed one by one by a pickup roller 42a, and conveyed to the image forming portion 108 through a conveying roller 42b disposed along a sheet of paper conveying path S2.

A registration rollers 26 are disposed below the transfer roller 36 and the transfer belt driving roller 32, and the registration rollers 26 convey a sheet of paper conveyed from the paper feeding portion 109 to the transfer roller 36 at such timing that a toner image on the transfer belt 31 is transferred to a predetermined position of the sheet of paper, whereby the toner image on the transfer belt 31 is transferred onto the sheet of paper.

The sheet of paper onto which the toner image is transferred is conveyed substantially vertically, and reaches the fixing unit 27 disposed above the transfer roller 36. The fixing unit 27 includes a heating roller 27a and a pressuring roller 27b, keeps the heating roller 27a at a predetermined fixture temperature by controlling heating means such as a heater lamp on the basis of a detection value of a temperature detector (not shown), rotates the heating roller 27a and the pressuring roller 27b in the state where the sheet of paper onto which the toner image is transferred is sandwiched by the heating roller 27a and the pressuring roller 27b, and thermally fixes the toner image onto the sheet of paper by heat of the heating roller 27a. The sheet of paper on which the toner image is thermally fixed is discharged by a conveying roller 27c disposed near the outlet of the fixing unit 27.

In the case of a single-side printing request, the sheet of paper passed through the fixing unit 27 is discharged onto a discharge tray 43 through a discharge roller 28 in the state where the image formed surface of the sheet of paper faces downward. On the other hand, in the case of a double-side printing request, the sheet of paper is temporarily retained by the discharge roller 28, and the sheet of paper is guided to a double-side document conveying path S3 by causing the discharge roller 28 to reversely rotate, and conveyed to the registration rollers 26 again by conveying rollers 29a, 29b. Then, a toner image is transferred and thermally fixed on another side of the sheet of paper, and the sheet of paper is discharged onto the discharge tray 43 by the discharge roller 28.

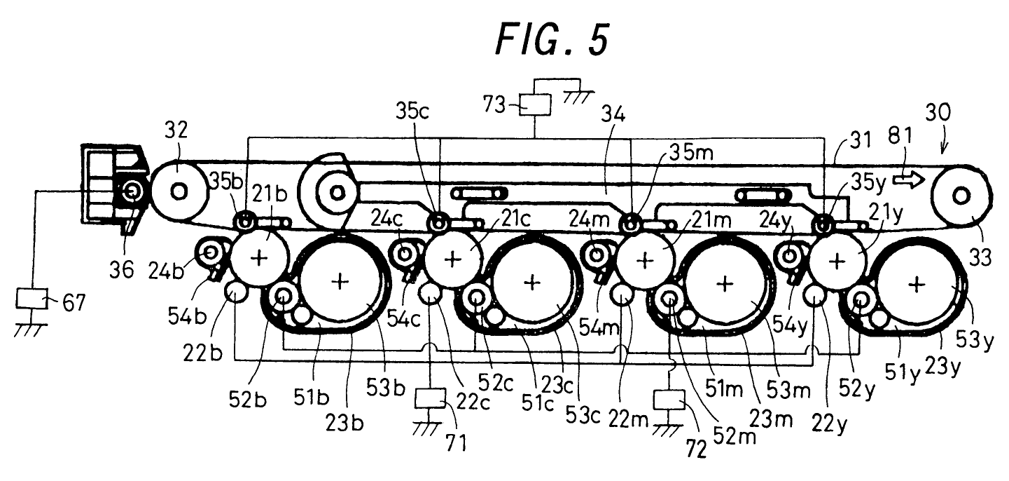

FIG. 5 is a magnified view of the essential part of a color image forming apparatus according to still another embodiment of the invention. The color image forming apparatus of the present embodiment is similar to the color image forming apparatus 101 of the aforementioned embodiment, so that corresponding portions will be denoted by the same reference numerals and the description thereof will be omitted, and a configuration view of the whole will be omitted.

What should be noted in the color image forming apparatus of the present embodiment is that a single charge voltage applying means 71, a single developing bias applying means 72, and a single first transfer voltage applying means 73 are disposed. As these voltage applying means, a rectifying unit provided with a transformer and a rectifier, a converter or the like can be used as in the aforementioned case.

By using the color image forming developer of the invention as a developer, the volume resistivity of the black developer 51b and the volume resistivities of the color developers 51y-c of yellow, magenta and cyan become substantially equal, so that a difference in charge property is not generated between the black developer 51b and the color developers 51y-c of yellow, magenta and cyan.

Accordingly, it is possible to charge the photoconductors 21y-b by the single charge voltage applying means 71 in the charging process, it is possible to develop by applying developing bias by the single developing bias applying means 72 in the developing process, and it is possible to charge the intermediate transfer rollers 35y-b by the single first transfer voltage applying means 73 and transfer a color image to the transfer belt 31 in the intermediate transfer process.

Since the volume resistivities of all the developers are substantially equal as described above, there is no need to provide voltage applying means for each developer in all the processes, and it is possible to decrease the component count, so that it is possible to realize space saving. Moreover, since it is possible to obtain a favorable image even when applying a voltage under the same conditions for each color, the need for changing the setting for each developer is eliminated, and it is possible to simplify the configuration of the apparatus.

The invention is not limited to the abovementioned embodiments, and it is needless to say that the abovementioned embodiments can be modified and changed within the scope of the invention.

### EXAMPLE

Hereinafter, an example of the invention will be described.

The black developer of the invention was produced by the use of equal weights of C.I. pigment yellow 17 as the yellow coloring agent 3y, C.I. pigment red 57:1 as the magenta coloring agent 3m and C.I pigment blue 15 as the cyan coloring agent 3c so that the density of the coloring agent in the developer became 7% by weight.

Further, the yellow developer was produced by the same method as the black developer except that only the aforementioned yellow coloring agent 3y was used as the coloring agent 3.

The magenta developer was produced by the same method as the black developer except that only the aforementioned magenta coloring agent 3m was used as the coloring agent 3.

The cyan developer was produced by the same method as the black developer except that only the aforementioned cyan coloring agent 3c was used as the coloring agent 3.

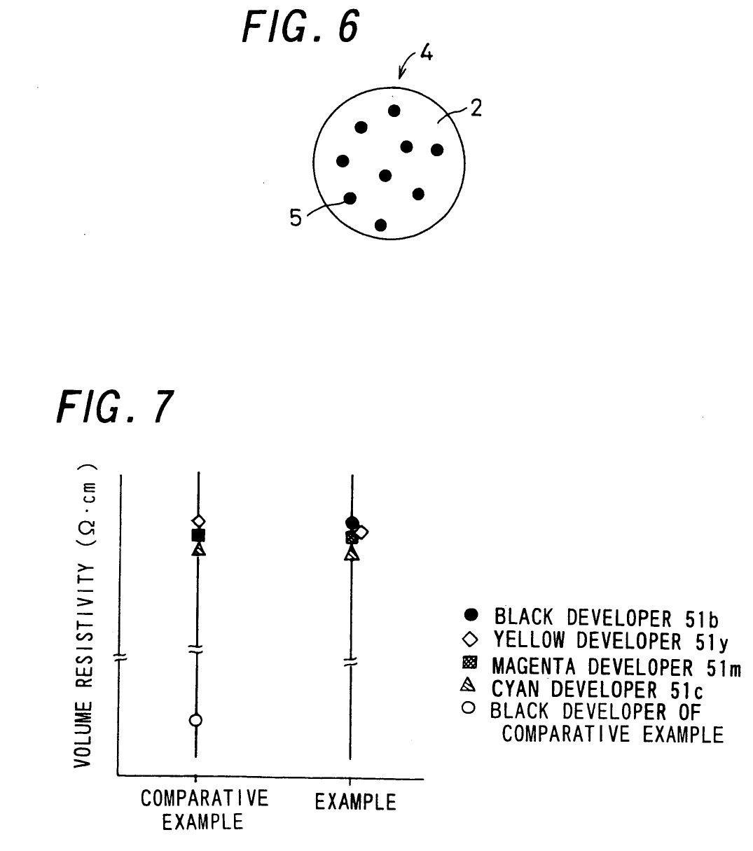

On the other hand, as a comparative example, a black developer of the comparative example was produced by the same method as the black developer of the invention except that carbon black was used as a coloring agent. FIG. 6 is a schematic cross section view showing, in a simplified manner, the structure of toner 4 of the black developer using carbon black 5 as a coloring agent according to the comparative example to the invention.

The yellow developer, the magenta developer, the cyan developer and the black developer produced in the above manner, and the black developer using the carbon black 5 as a coloring agent of the comparison example were pressurized so as to become pellets, and measured by a dielectric loss measuring apparatus (produced by Ando Electric Co., Ltd.). The result is shown in FIG. 7. The color developers of yellow, magenta and cyan exhibited volume resistivities of 1×10¹¹±0.5×10¹¹ Ω·cm. Moreover, the volume resistivity of the black developer of the invention was 1.8×10¹¹ Ω·cm, whereas the volume resistivity of the black developer using carbon black as a coloring agent of the comparison example was 9×10⁹±2.0×10⁹ Ω·cm.

It becomes clear from FIG. 7 that the volume resistivity of the black developer of the invention was substantially equal to the volume resistivities of the color developers of the yellow developer, the magenta developer and the cyan developer. Therefore, the black developer of the invention does not cause a difference in charge property between the black developer itself and the color developers even if going through the respective processes for forming a color image. In the case of using this developer in a color image forming apparatus, it is possible to obtain an image of high image quality in which the harmony of colors is maintained, and it is possible to miniaturize the color image forming apparatus by making the charge electric potential that a charging unit charges a photoconductor, the application voltage of a developing tank containing the developer and the conditions of agitating the developer in the developing unit, the transfer electric potential that the transfer unit applies to a to-be-transferred material and the contact pressure of a cleaning unit to the surface of the photoconductor the same for the black developer and the color developers, and simplify the configuration of the apparatus.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A color image forming developer for use in visualizing a latent image which is formed on the basis of image information separated into color components of yellow, magenta, cyan and black, the color image forming developer comprising:
a yellow developer which develops a latent image formed on the basis of image information relating to the color component of yellow;
a magenta developer which develops a latent image formed on the basis of image information relating to the color component of magenta;
a cyan developer which develops a latent image formed on the basis of image information relating to the color component of cyan; and
a black developer which develops a latent image formed on the basis of image information relating to the color component of black,
wherein a volume resistivity of the black developer is substantially equal to a volume resistivity of the yellow developer, a volume resistivity of the magenta developer, and a volume resistivity of the cyan developer.

2. The color image forming developer of claim 1, wherein each of the developers contains at least a binding resin and a coloring agent, and
the black developer contains a yellow coloring agent, a magenta coloring agent and a cyan coloring agent which are used for the yellow developer, the magenta developer and the cyan developer, respectively, at a predetermined ratio.

3. The color image forming developer of claim 2, wherein the predetermined ratio is such that weights of the yellow coloring agent, the magenta coloring agent and the cyan coloring agent are in substantially equal proportions.

4. The color image forming developer of claim 3, wherein the predetermined ratio is 1:1:1 by weight.

5. The color image forming developer of claim 3, wherein the predetermined ratio is (1.2-1.5):1:1 by weight.

6. The color image forming developer of claim 2, wherein a ratio of the sum of the weights of the yellow coloring agent, the magenta coloring agent and the cyan coloring agent in the black developer to the weight of the black developer is substantially equal to a ratio of the weight of the yellow coloring agent in the yellow developer to the weight of the yellow developer, a ratio of the weight of the magenta coloring agent in the magenta developer to the weight of the magenta developer, and a ratio of the weight of the cyan coloring agent in the cyan developer to the weight of the cyan developer.

7. A color image forming apparatus in which a latent image which is formed on the basis of image information separated into color components of yellow, magenta, cyan and black is visualized, the color image forming apparatus comprising:
a photoconductor on which a latent image is formed by being exposed to light according to image information;
a charging unit which charges the photoconductor before being exposed;
a developing unit which is equipped with the color image forming developer of claim 1, agitates and charges the color image forming developer, and supplies the color image forming developer to the surface of the photoconductor to visualize the latent image;
a transfer unit which applies electric potential of an opposite polarity to a polarity of the color image forming developer to a to-be-transferred material and transfers the visualized image; and
a cleaning unit which removes the color image forming developer that remains on the surface of the photoconductor after transfer,
wherein at the time of image formation, the operation conditions of the charging unit, the developing unit, the transfer unit and the cleaning unit are set to same ones for the respective color developers of yellow, magenta and cyan and the black developer.

8. The color image forming apparatus of claim 7, wherein the operation conditions include at least charge electric potential at which the charging unit charges the photoconductor, an application voltage of a developer tank which contains the developer and a condition of agitating the developer in the developing unit, transfer electric potential at which the transfer unit applies to the to-be-transferred material, and a contact pressure of the cleaning unit to the surface of the photoconductor.
